(19) United States
(12) Patent Application Publication
(10) Pub. No.: US 2010/0137761 A1
(43) Pub. Date: Jun. 3, 2010

(54) MASSAGE APPARATUS

(76) Inventor: Shohei Taniguchi, Ibaraki-shi (JP)

Correspondence Address: Cheng Law Group, PLLC, 1100 17th Street, N.W., Suite 503, Washington, DC, 20036, US

(21) Appl. No.: 12/598,879

(22) PCT Filed: Aug. 3, 2007
(86) PCT No.: PCT/JP2007/065282

§ 371 Date: Nov. 4, 2009

(51) Int. Cl. A61H 15/00

(52) U.S. Cl. 601/112

(57) ABSTRACT

A massage apparatus in this invention comprises a massage mechanism, an actuator, and a controller. The massage mechanism has at least three rotational or translational joints to which an applicator is connected for contact with a human body. The actuator is configured to drive each of the joints independently from each other. The displacement detection means is configured to detect a displacement of each of the joints. The controller is provided for controlling the actuators. The controller is configured to provide a predetermined trace control plane. The controller comprises a position control means and a force control means. The position control means is provided for controlling a tracing path of the applicator in the trace control plane. The force control means is provided for controlling a force exerted by the applicator in a normal direction to the trace control plane.

### TECHNICAL FIELD

The present invention is directed to a massage apparatus, and more particularly such an apparatus with a massage mechanism incorporated in a backrest of a chair.

### BACKGROUND ART

There have been provided a wide variety of massage apparatus with a massage mechanism incorporated in a chair's backrest, as seen in Japanese Patent No, 2733159. The apparatus includes the massage mechanism which is mounted on a fixed frame to make a force control in a direction perpendicular to a frame plane and a position control relative to the frame plane.

When making the massage to a user, it is an optimum control to make the position control along a contour of the user's body while making a force control in a depth direction with respect to the contour of the user's body. However, since the frame plane is not designed to follow the contour of the user's body, there is a need of improving the force control.

### DISCLOSURE OF THE INVENTION

In view of the above, the present invention has been achieved to provide a massage apparatus which is capable of arbitrarily setting a magnitude as well as a three-dimensional direction of a force vector exerted by an applicator, and determining an arbitrary massage path with respect to a plane perpendicular to the direction of the force vector.

The massage apparatus in accordance with the present invention includes a massage mechanism which is provided with at least three rotational or transitional joints to which an applicator is connected for contact with a human body. The massage apparatus includes an actuator configured to drive the joints independently from each other, a displacement detection means configured to detect a displacement of each joint, and a controller configured to control the actuators. The controller is configured to provide a predetermined trace control plane, and includes a position control means for controlling a tracing path of the applicator, and a force control means for controlling a force exerted by the applicator in a direction normal to the trace control plane within the trace control plane.

Accordingly, the massage apparatus of the present invention allows an arbitrary selection of the trace control plane with a resulting capability of determining the three-dimensional directions along which the force vector is given by the applicator. The trace path of the applicator is given in the trace control plane perpendicular to the direction of the force vector. Thus, it is possible to constantly obtain a predetermined in-plane path with a predetermined pressing direction against the user.

Preferably, the position control means is configured to calculate a current position of the applicator based on the displacements of the joints detected by the displacement detection means so as to determine a deviation between the current position of the applicator and a target position of the applicator, or determine a deviation between a target value of each joint and a current displacement of each joint detected by said displacement detection means. The position control means is configured to control each of the actuators based upon thus determined deviation. In this instance, a feedback control is enabled to realize the predetermined in-plane path accurately.

Preferably, the position control means is configured to control the position of the applicator with the use of Jacobian between a parallel plane to the trace control plane and a joint coordinate system, and give no target value of the applicator with respect to a direction parallel to the trace control plane when making the feedback control of the position of the applicator. In this instance, the force can be free from a displacement error in the positional control, when the positional control within the trace control plane is made concurrently with the force control along the direction perpendicular to the trace control plane.

The controller may be configured to give a torque command to the actuator of each of the joints for driving the same. In this instance, the force is controlled not only in its direction but also in its magnitude.

Preferably, the massage apparatus includes a force sensor for detection of a force exerted from the applicator to a user. The force control means is configured to control each actuator based upon a deviation between the target value of the force and a current value of the force detected by the force sensor. In this instance, the feedback control of the force is enabled to realize a predetermined pressing force accurately.

Further, it is preferred that a memory device is included to store target values of the displacement and the force of the applicator. In this connection, the controller is configured to control the position and the force of the applicator based upon a deviation between the target values of the displacement and the force stored in the memory device and current values of the displacement and the force. Accordingly, it is possible to reproduce a predetermined massage action.

Further, the controller is preferred to vary the trace control plane successively to make the trace control plane in parallel with a tangential direction of a contact portion of the user's body. In this instance, it is possible to make the massage always with the desired trace and with desired force in accordance with irregular surface of the human body.

Furthermore, it is preferred to have a manipulator which is accessible by the user for adjustment of the force and the direction of the applicator in order to realize the direction and magnitude of the force as determined by the user.

The controller may be configured to give a speed demand value to driving the actuator of each of the joints, which enables the control of the direction and the magnitude of the force at a less cost than relying upon the control of giving the torque command.

Further, a manipulator may be included to adjust a force tracking of the applicator. In this connection, the force control means is configured to adjust a control gain based on an input at the manipulator so as to vary the force tracking in a manner as preferred by the user.

The force control means may be configured to increase the force tracking to a greater extent when the applicator is moving away from the human body than moving towards the human body. Thus, the user can enjoy a comfortable massage free from a situation where the applicator responds to follow the user's body too quickly which might otherwise occur when the massage force of less than the predetermined magnitude is selected, or a situation where the applicator responds to be released too quickly from the user's body with an excessive force gap which might otherwise occur when the massage force of greater than the predetermined magnitude is selected.

### BRIEF DESCRIPTION OF THE DRAWINGS

FIG. 1 is a block diagram of a massage apparatus in accordance with one embodiment of the present invention;

FIG. 2 is a block diagram of a massage apparatus having a force sensor in accordance with one embodiment of the present invention;

FIG. 3 is a block line chart explaining the control of the massage apparatus of FIG. 1;

FIG. 4 is a block line chart explaining the control of the massage apparatus of FIG. 2;

FIG. 5 is a view for explanation of trace control coordinate system;

FIG. 6 is a block diagram illustrating a memory device added to the block diagram of FIG. 2;

FIG. 7 is a view for explanation of a manipulator;

FIG. 8 is a block diagram for explaining a control of each actuator based on a speed command;

FIG. 9 is a view for explanation of a manipulator used for entry of force tracking of an applicator;

FIG. 10 is a view explaining the force tracking of the applicator; and

FIG. 11 is a view for explanation of the coordinate axes.

### BEST MODE FOR CARRYING OUT THE INVENTION

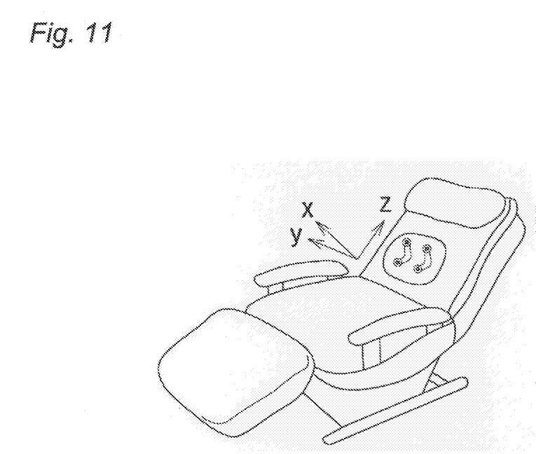

Now, a detailed explanation of the invention is made with reference to the attached drawings. A massage apparatus in accordance with the present invention includes an applicator provided at a distal end of a massage mechanism having at least three joints. As shown in FIG. 11, the massage mechanism is mounted on a frame forming a y-z plane. Although the massage apparatus having such massage mechanism can be derived from JP2006-34635, the present invention is not limited thereto.

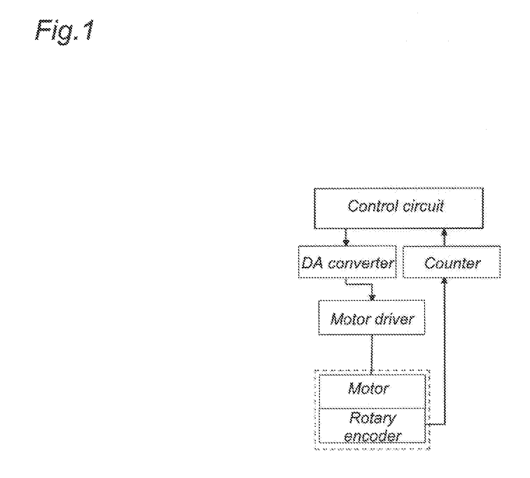

As shown in FIG. 1, each of the joints is equipped with an actuator in the form of a motor, a displacement sensor in the form of a rotary encoder for detection of displacement, a control circuit (controller) that receives a value through a counter from the rotary encoder to determine a motor demand value for driving the motor through a DA converter and a motor driver. The motor demand value is preferably a torque command.

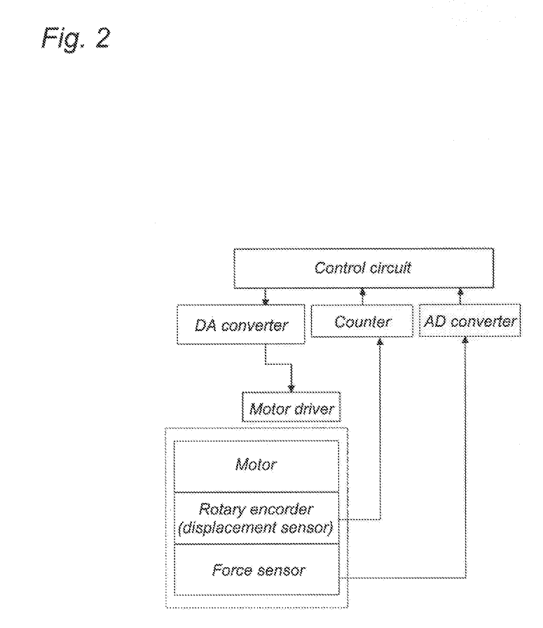

FIG. 2 shows the massage apparatus shows the massage apparatus having the applicator provided with a force sensor for detection of a force applied from the applicator to the user. The force sensor provides its detection output to the control circuit through an AD converter. The force sensor is important in making a force feedback as described later, however, it is not necessarily essential.

Now, control of the massage apparatus is explained in details. In the present embodiment, the controller is configured to determine a predetermined trace control plane, and includes a position control means for controlling a trace of the applicator within the trace control plane, and a force control means for controlling a force that the applicator generates in a direction perpendicular to the trace control plane.

The force control means is configured to determine the force of the applicator based upon the positional information of the applicator, and covert it into individual motor outputs by use of a matrix for making the force control.

The position control means is configured to control the position of the applicator based upon a deviation between a target value of the displacement of the joints and the present value of the displacements of the joints detected by the displacement sensor.

In this instance, the motor demand value “u” is determined, for example, by a following equation 1:

u=KₚΔq+KᵥΔ\dot{q}−J_{φ}(q)^{T}f_{d} [Equation 1]

u is the motor demand value.
Kp is a position gain.
Kv is a speed gain.
Δq=qd−q
Δq is a positional deviation.
qd is a target joint displacement.
q is a current joint displacement
JF is a vector converting the force of the applicator into the individual motor outputs.
fd is a target force.
A superscript “T” denotes transposition.

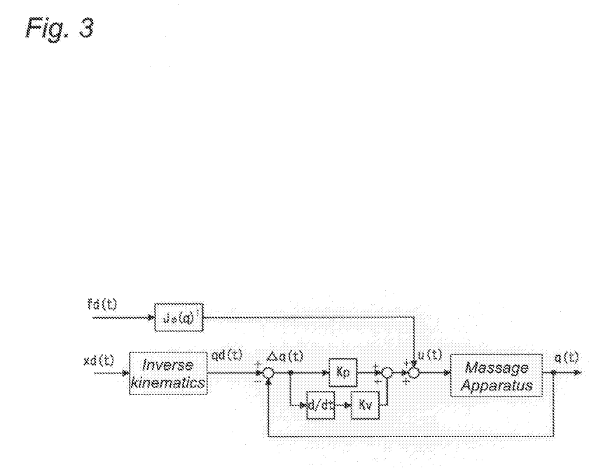

FIG. 3 shows a block line chart of the above case, in which “x” indicates a position vector of the applicator, subscript “d” indicates the target value. “Inverse kinematics” in FIG. 3 denotes a calculation of converting the position vector “x” of the applicator into joint vector “q”.

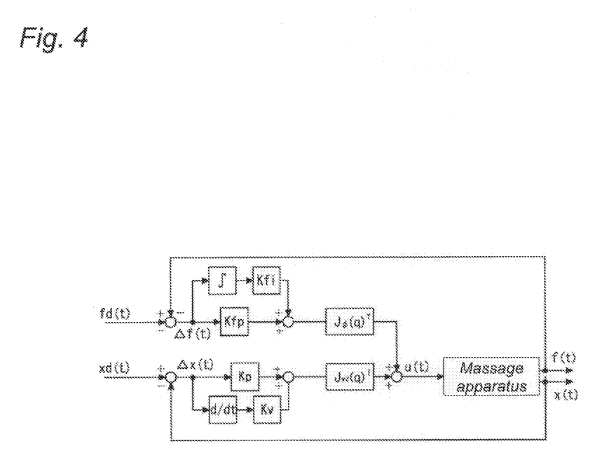

On the other hand, in a case where the trace control plane, which is a plane for controlling the applicator's trace, is perpendicular to a direction for controlling the applicator's force and the force sensor is attached, the force control means determines the motor demand value shown in equation 2 on the basis of the deviation calculated from the target value of the force and a present value of the force which is detected by the force sensor. Subsequently, the position control means determines the motor demand value shown in equation 2 on the basis of the deviation calculated from the relation between the target position of the applicator and present position of the applicator calculated from the displacements of the joints detected by the displacement sensor. FIG. 4 shows the block line chart in this case.

u=J_{yz}(q)^{T}{K_{yzp}Δx_{yz}+K_{yzv}Δ\dot{x}_{yz}}−J_{φ}(q)^{T}f_{d}+K_{fp}−J_{φ}(q)^{T}Δf−K_{fi}∫J_{φ}(q)^{T}Δfdt [Equation 2]

Kyzp is the position gain
Kyzv is the speed gain
Δxyz=xyzd−xyz
Δxyz is a positional deviation
Xyz=[y,z]̂T
Jyz is a Jacobian between the y-z plane and the joint coordinate system.
Kfp is a proportional gain.
fd is the target force.
f is a the present massage force.
Δf=fd−f
Δf is a force deviation

Here, a control row considering the position control within a plane parallel to the y-z plane as mentioned above and the force control toward the x direction perpendicular to the y-z plane is indicated. However, it is possible to determine the direction arbitrarily if a condition that the force control direction is perpendicular to the position control direction is satisfied.

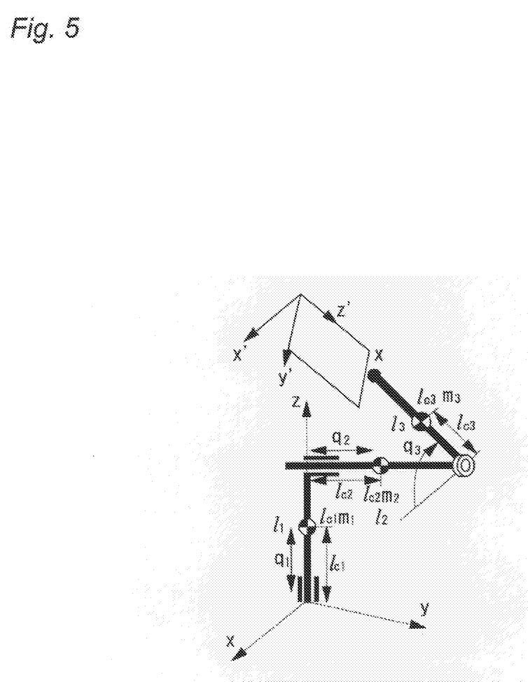

Hereinafter, a method of setting a force direction which is directed toward the arbitrarily direction is explained. As shown in FIG. 5, a plane that the position control is performed is described by a following formula. z=ax+by+c On the basis thereof, a geometrical constraint f (x) of the applicator is represented by the following equation 3.

φ(x)=z−ax−by−c=0 [Equation 3]

In addition, x is a three-dimensional position vector at the distal end of the applicator, thereby x being represented by a following equation. x=(x, y, z) Under the condition, a new coordinate system of o-x′y′z′ with respect to the plane is defined. In this case, the position control is performed within Y′-Z′ plane, and the force control is performed within X′ direction.

Considering the equation 3, the normal line vector f x is represented by a following equation (4).

φₓ=(∂φ(x)/∂x)^{T}=(∂φ(x)/∂x,∂φ(x)/∂y,∂φ(x)/∂z)^{T} [Equation 4]

Here, the Jacobian between position x=(x, y, z) of the distal end of the applicator and q=(q1, q2, q3) of the joint coordinate system is determined as a following equation 5.

$$Jx ( q ) = ( \begin{matrix}\partial x / \partial {q}_{1} & \partial x / \partial {q}_{2} & \partial x / \partial {q}_{3} \\ \partial y / \partial {q}_{1} & \partial y / \partial {q}_{2} & \partial y / \partial {q}_{3} \\ \partial z / \partial {q}_{1} & \partial z / \partial {q}_{2} & \partial z / \partial {q}_{3}\end{matrix} ) \qquad [ Equation 5 ]$$

Furthermore, the transform vector Jf for each joint force in order to generate the force along the normal direction perpendicular to the plane is defined by equation 6 which is determined on the basis of the equation 4 and the equation 5.

$${{J}_{φ} ( q )}^{T} = \frac{{{J}_{x} ( q )}^{T} ( \partial φ / \partial x )}{‖ {φ}_{x} ‖} \qquad [ Equation 6 ]$$

The equation 6 indicates the transform vector for each joint force in order to generate the force along the normal direction with respect to a plane defined by the equation 3. Each joint force which exerts the force toward the arbitrarily direction is obtained by modifying parameters of “a”, “b”, and “c” in the equation 3.

Subsequently, followings indicates a method for determining the Jacobian Jyz(q) for controlling the position. Rotating matrix from a standard coordinate o-xyz to a coordinate o-x′y′z′ is designated by R. Consequently, position vector of the applicator is expressed by the coordinate o-x′y′z′. By expressing the coordinate o-x′y′z′ as an equation of “x′=(x′, y′, z′)”, Relation between x and x′ is represented by an equation 7.

x′=Rx [Equation 7]

Similarly, Δxyz also expressed by the coordinate o-x′y′z′. On the basis thereof, the Jacobian Jyz(q) of the y-z plane of the equation 2 and the joint coordinate system is represented by equation 8.

$${J}_{yz} ( q ) = ( \begin{matrix}\partial {y}^{′} / \partial {q}_{1} & \partial {y}^{′} / \partial {q}_{2} & \partial {y}^{′} / \partial {q}_{3} \\ \partial {z}^{′} / \partial {q}_{1} & \partial {z}^{′} / \partial {q}_{2} & \partial {z}^{′} / \partial {q}_{3}\end{matrix} ) \qquad [ Equation 8 ]$$

As mentioned above, it is possible to determine the direction arbitrarily if the direction of the force control is perpendicular to the direction of the position control. Therefore, the controller is configured to gradually modify the trace control plane such that the trace control plane is parallel to the tangential direction of a contact portion of the user's body. Consequently, the controller controls the applicator such that the applicator is moved along the user's dorsal surface and provides the user's dorsal surface to the force which is perpendicular to the user's dorsal surface. Therefore, it is possible to apply an optimum massage.

As being understood by the equation 2, the position control means performs the position control of the applicator by using the Jacovian Jyz(q). However, when the position control means performs the feedback control of the position, the position control means sets the target value of the applicator's position which is not coincided with a position parallel to the trace control plane. Consequently, the force is free from the displacement error of the position control.

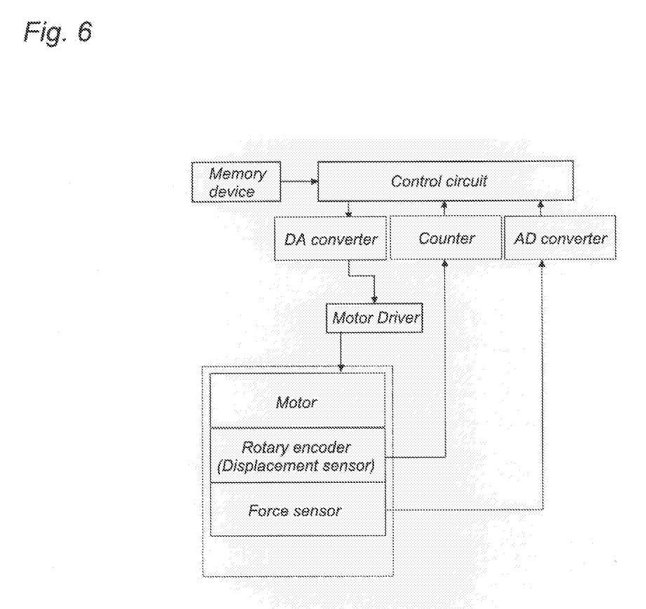

FIG. 6 shows a massage apparatus which comprises a memory device in addition to the massage apparatus in FIG. 2. The memory device previously is configured to store the displacement of the applicator and the target value of the force. The controller controls the applicator's position and the force on the basis of the deviation of the present value and the target value of the force and the displacement stored in the memory device. In this case, it is possible to easily duplicate the massage action which is suitable for the individual user.

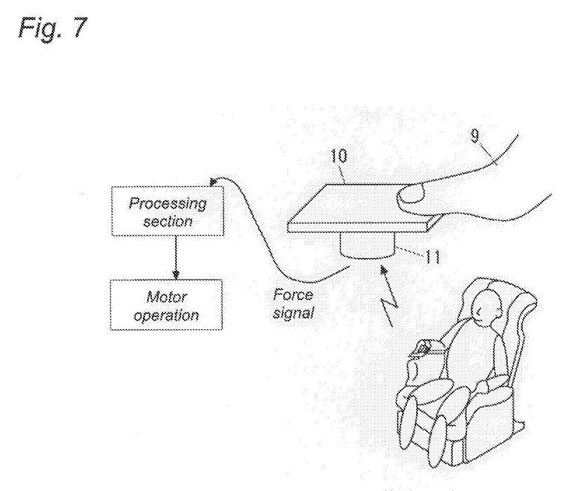

In addition, it is also preferred that the massage apparatus further comprises a manipulator 10. The manipulator 10, shown in FIG. 7, is configured to set amplitude and the direction of the force of the applicator by the user. Consequently, the manipulator 10 is operated by the user's finger 9, thereby the direction and the amplitude of the force of the applicator is varied by the manipulator 10. In FIG. 7, a triaxial force sensor 11 disposed in the manipulator 10 detects the direction and the amplitude of the force of operation. The controller recognizes the direction and the amplitude of the force of the operation as the target value, and subsequently controls the applicator on the basis of the target value.

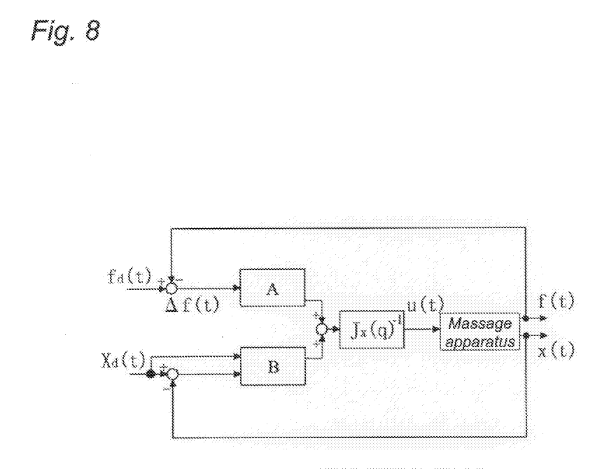

In the above embodiment, the case where each actuator is operated according to the torque command value is explained. However, it is also possible to control the force and the trace according to the speed demand value. FIG. 8 shows an example that the force and the trace are controlled according to the speed demand value. In a case where the force is controlled, as shown in FIG. 8 (a), if the present massage force is larger than the desired force, the control input of the force, which contains the speed demand value of directing the applicator away from the user's body, is generated. On the other hand, if the present massage force is smaller than the desired force, the control input of the force, a letter of A shown in FIG. 8 which contains the speed demand value of directing the applicator toward the user's body, is generated. In addition, when the trace is controlled, the control input containing the speed demand value which conduce the desired trace is generated. At this time, the displacement of the position and the speed is fed back, thereby the speed demand value being generated. This speed demand value is superimposed on the speed demand value which conduce the desired trace, thereby the control input of the trace being generated. The speed demand value which is composed of the control input of the force superimposed on the control input of the trace is the speed demand of the applicator. Therefore, the speed demand is transformed into the speed demand value of each actuator. The speed demand value is input to each actuator.

\dot{q}=Jₓ(q)⁻¹\dot{x} [Equation 9]

In a case where the force control is performed along the x direction and the position control is performed within y-z direction, relation represented in equation 10 is able to be recognized.

$$\dot{x} = ( \begin{matrix}- {K}_{fp} Δ f - {K}_{fi} \int Δ f \\ {\dot{y}}_{d} + {K}_{p} Δ y + {K}_{v} Δ \dot{y} \\ {\dot{z}}_{d} + {K}_{p} Δ z + {K}_{v} Δ \dot{z}\end{matrix} ) \qquad [ Equation 10 ]$$

In this case, “A” in FIG. 8 corresponds to equation 11. “B” in FIG. 8 corresponds to equation 12.

$$\begin{matrix}( \begin{matrix}- {K}_{fp} Δ f - {K}_{fi} \int Δ f \\ 0 \\ 0\end{matrix} ) & [ Equation 11 ] \\ ( \begin{matrix}0 \\ {\dot{y}}_{d} + {K}_{p} Δ y + {K}_{v} Δ \dot{y} \\ {\dot{z}}_{d} + {K}_{p} Δ z + {K}_{v} Δ \dot{z}\end{matrix} ) & [ Equation 12 ]\end{matrix}$$

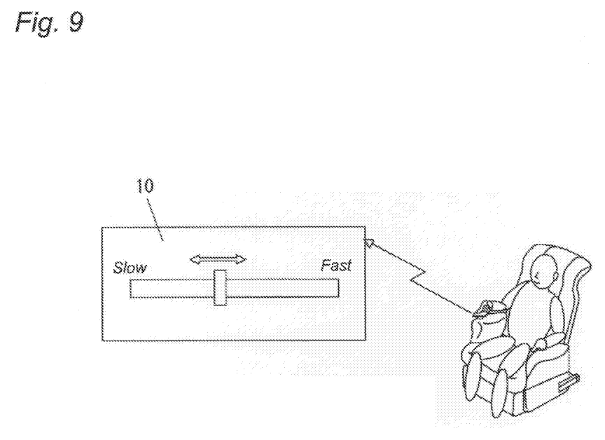

By the way, when the force applied to the users by the applicator is allowed to track the desired force, the force tracking of the force is varied by the feedback term with respect to the force displacement. Namely, the force tracking is enhanced when the control gain with regard to the force is enhanced. On the other hand, the force tracking is diminished when the control gain with regard to the force is changed to diminished. It is also preferred that the force tracking is able to be selected by the user. FIG. 9 shows the massage apparatus comprising a manipulator 10. This manipulator 10 has a knob configured to be moved linearly for adjusting the force tracking. When the manipulator 10 is operated by the user, the force control means adjusts the control gain on the basis of input of the manipulator 10 of the user. Consequently, the force tracking is varied. The manipulator is not limited thereto. It is possible to employ the manipulator which is configured to adjust the force tracking.

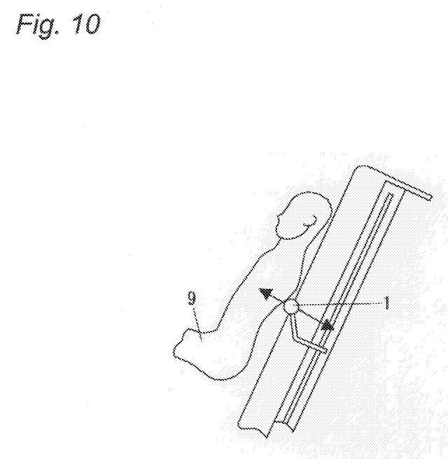

In addition, it is preferred that the control means is configured to increase the force tracking to a greater extend when the applicator 1 is moving away from the human body 12 (a direction in FIG. 10) than moving towards the human body (B direction in FIG. 10). That is, when difference of the desired force fd and the current force f is positive value, the present massage force is weak. Therefore, the applicator is moved toward the user's body. At this time, the low-tracking of the applicator is obtained by diminishing the control gain. Therefore, the massage force is gradually enlarged. Consequently, the user does not feel pain. In contrast, when the difference of the desired force fd and the current force f is negative value, the present massage force is too strong. Therefore, the applicator is moved away from the user's body. At this time, the high-tracking of the applicator is obtained by enhancing the control gain. Therefore, the massage force is immediately weakened when the user feels the pain because the massage force is strong. Consequently, this configuration makes it possible to provide the comfortable massage to the user.

1. A massage apparatus comprising:
a massage mechanism having at least three rotational or translational joints to which an applicator is connected for contact with a human body,
an actuator configured to drive each of said joints independently from each other;
a displacement detection means configured to detect a displacement of each of said joints; and
a controller for controlling said actuators,
wherein said controller is configured to provide a predetermined trace control plane, and comprises a position control means for controlling a tracing path of said applicator in said trace control plane, and a force control means for controlling a force exerted by said applicator in a normal direction to said trace control plane,
wherein said controller is configured to give a speed demand value to driving the actuator of each of said joints.

2. A massage apparatus as set forth in claim 1, wherein
said position control means is configured to calculate a current position of the applicator based on the displacements of said joints detected by said displacement detection means so as to determine a deviation between the current position of the applicator and a target position of the applicator, or determine a deviation between a target value of each said joint and a current displacement of each said joint detected by said displacement detection means,
said position control means being configured to control each of said actuators based upon thus determined deviation.

3. A massage apparatus as set forth in claim 1, wherein
said position control means is configured to control the position of said applicator with the use of Jacobian between a parallel plane to said trace control plane and a joint coordinate system, and give no target value of said applicator with respect to a direction parallel to said trace control plane when making a feedback control of the position of the applicator.

4. (canceled)

5. A massage apparatus as set forth in claim 1, further comprising:
a force sensor for detection of a force exerted from said applicator to a user;
said force control means being configured to control each said actuator based upon a deviation between the target value of the force and a current value of the force detected by the force sensor.

6. A massage apparatus as set forth in claim 1, further comprising:
a memory device configured to store target values of the displacement and the force of the applicator,
said controller being configured to control the position and the force of the applicator based upon a deviation between the target values of the displacement and the force stored in said memory device and current values of the displacement and the force.

7. A massage apparatus as set forth in claim 1, wherein
said controller is configured to vary said trace control plane successively to make the trace control plane in parallel with a tangential direction of a contact portion of the user's body.

8. A massage apparatus as set forth in claim 1, further comprising:
a manipulator accessible by the user for adjustment of the force and the direction of the applicator.

9. (canceled)

10. A massage apparatus as set forth in claim 5, further comprising:
a manipulator configured to adjust a force tracking of the applicator,
said force control means being configured to adjust a control gain based on an input at said manipulator.

11. A massage apparatus as set forth in claim 5, wherein
said force control means is configured to increase the force tracking to a greater extent when the applicator is moving away from the human body than moving towards the human body.
